(19) United States
(12) Patent Application Publication
(10) Pub. No.: US 2026/0210009 A1
(43) Pub. Date: Jul. 23, 2026

(54) COMPOSITE NONWOVEN

(71) Applicant: Milliken & Company, Spartanburg, SC (US)

(72) Inventors: Kazuaki Shibata, Simpsonville, SC (US); Heather Pretorius, Greenville, SC (US)

(21) Appl. No.: 19/453,142

(22) Filed: Jan. 20, 2026

Related U.S. Application Data
(60) Provisional application No. 63/748,716, filed on Jan. 23, 2025.

(51) Int. Cl. D04H 1/4382; B32B 5/02; B32B 5/06; B32B 5/08; B32B 5/26; D04H 1/435; D04H 1/4374; D04H 1/485; D04H 1/498; D06C 7/00

(52) U.S. Cl. CPC D04H 1/43835; B32B 5/022; B32B 5/06; B32B 5/08; B32B 5/271; D04H 1/435; D04H 1/4374; D04H 1/43825; D04H 1/485; D04H 1/498; D06C 7/00; B32B 2250/20; B32B 2262/0276; B32B 2262/124; B32B 2262/144; B32B 2307/102; B32B 2307/546; B32B 2307/718; D10B 2331/04

(57) ABSTRACT

A composite nonwoven containing a first nonwoven layer and a second nonwoven layer. The first nonwoven layer forms the upper surface of the nonwoven composite. The first nonwoven layer contains at least 90% by weight of a plurality of polyethylene terephthalate glycol fibers. The second nonwoven layer forms the lower surface of the composite nonwoven. The second nonwoven layer contains an intimate blend of a plurality of polyester terephthalate fibers, a plurality of first bi-component polyester fibers having a melting temperature of less than 140° C. and a plurality of second bi-component polyester fibers having a melting temperature of greater than 150° C. At least a portion of the polyethylene terephthalate glycol fibers from the first nonwoven layer are needled into the second nonwoven layer and at least 90% by weight of the composite nonwoven is polyester.

### RELATED APPLICATIONS

This application claims priority to U.S. Provisional Application 63/748,716 filed on Jan. 23, 2025, which is herein incorporated by reference in its entirety.

### TECHNICAL FIELD OF THE INVENTION

The invention provides a nonwoven composite and a molded nonwoven composite having good physical properties.

### BACKGROUND

There are a number of products in various industries, including automotive, office and home furnishings, construction, and others; that require materials having a z-direction thickness to provide both structural strength as well as thermal, sound insulation, aesthetic, and/or other performance features. In many of these applications it is also required that the material be thermoformable to a specified shape and rigidity. In the automotive industry these products often are used for shielding applications such as noise and thermal barriers in automotive hood liners, underbody shields, firewall barriers, floor liners, carpeting, and trunk liners.

Composite materials used in automotive applications like package shelves, door panels or headliners are often produced via heating and then cold pressing structural nonwoven composite layers bound by a thermoplastic binder fiber to a decorative layer.

It would be preferably to be able to create an easy to manufacture and use composite that used thermoplastic materials and would be more recyclable than other products currently in the marketplace.

### BRIEF SUMMARY OF THE INVENTION

The invention relates to a composite nonwoven having an upper surface and a lower surface and containing a first nonwoven layer and a second nonwoven layer. The first nonwoven layer has a first side and a second side, where the first side of the first nonwoven layer forms the upper surface of the nonwoven composite. The first nonwoven layer contains a plurality of polyethylene terephthalate glycol fibers, and the first nonwoven layer comprises at least 90% by weight polyethylene terephthalate glycol. The second nonwoven layer has a first and second side, where the second nonwoven layer is oriented such that the first side of the second nonwoven layer faces the second side of the first nonwoven layer and the second side of the second nonwoven layer forms the lower surface of the composite nonwoven. The second nonwoven layer contains an intimate blend of a plurality of polyester terephthalate fibers, a plurality of first bi-component polyester fibers having a melting temperature of less than 140° C. and a plurality of second bi-component polyester fibers having a melting temperature of greater than 150° C. At least a portion of the polyethylene terephthalate glycol fibers from the first nonwoven layer are needled into the second nonwoven layer and at least 90% by weight of the composite nonwoven is polyester.

The invention also relates to a process of forming a composite nonwoven having an upper surface and a lower surface and containing the steps of forming a first nonwoven layer, forming a second nonwoven layer, and needling the first nonwoven layer and the second nonwoven layer together. The first nonwoven layer is formed by entangling a plurality of polyethylene terephthalate glycol fibers, where the first nonwoven layer has a first side and a second side and wherein the first nonwoven layer comprises at least 90% by weight polyethylene terephthalate glycol. The second nonwoven layer is formed by entangling a plurality of polyester terephthalate fibers, a plurality of first bi-component polyester fibers having a melting temperature of less than 140° C. and a plurality of second bi-component polyester fibers having a melting temperature of greater than 150° C. The second nonwoven layer has a first and second side, and the second nonwoven layer is oriented such that the first side of the second nonwoven layer faces the second side of the first nonwoven layer. The first nonwoven layer and the second nonwoven layer are needled together, pushing a portion of the polyethylene terephthalate glycol fibers from the first nonwoven layer into the second nonwoven layer. The first side of the first nonwoven layer forms the upper surface of the nonwoven composite and the second side of the second nonwoven layer forms the lower surface of the composite nonwoven and at least 90% by weight of the composite nonwoven is polyester.

The invention also relates to a molded composite nonwoven having an upper surface and a lower surface and containing a first nonwoven layer and a second nonwoven layer. The first nonwoven layer has a first side and a second side, where the first side of the first nonwoven layer forms the upper surface of the nonwoven composite. The first nonwoven layer contains a plurality of polyethylene terephthalate glycol fibers, and the first nonwoven layer comprises at least 90% by weight polyethylene terephthalate glycol. At least a portion of the polyethylene terephthalate glycol fibers have been at least partially melted and rehardened into a porous skin. The second nonwoven layer has a first and second side, where the second nonwoven layer is oriented such that the first side of the second nonwoven layer faces the second side of the first nonwoven layer and the second side of the second nonwoven layer forms the lower surface of the composite nonwoven. The second nonwoven layer contains an intimate blend of a plurality of polyester terephthalate fibers, a plurality of first bi-component polyester fibers having a melting temperature of less than 140° C. and a plurality of second bi-component polyester fibers having a melting temperature of greater than 150° C. At least a portion of the polyethylene terephthalate glycol fibers from the first nonwoven layer are needled into the second nonwoven layer and at least 90% by weight of the composite nonwoven is polyester.

The invention also relates to a process of forming a composite nonwoven having an upper surface and a lower surface and containing the steps of forming a first nonwoven layer, forming a second nonwoven layer, needling the first nonwoven layer and the second nonwoven layer together, and applying heat and pressure to the composite nonwoven to form the molded composite nonwoven. The first nonwoven layer is formed by entangling a plurality of polyethylene terephthalate glycol fibers, where the first nonwoven layer has a first side and a second side and wherein the first nonwoven layer comprises at least 90% by weight polyethylene terephthalate glycol. The second nonwoven layer is formed by entangling a plurality of polyester terephthalate fibers, a plurality of first bi-component polyester fibers having a melting temperature of less than 140° C. and a plurality of second bi-component polyester fibers having a melting temperature of greater than 150° C. The second nonwoven layer has a first and second side, and the second nonwoven layer is oriented such that the first side of the second nonwoven layer faces the second side of the first nonwoven layer. The first nonwoven layer and the second nonwoven layer are needled together, pushing a portion of the polyethylene terephthalate glycol fibers from the first nonwoven layer into the second nonwoven layer. The first side of the first nonwoven layer forms the upper surface of the nonwoven composite and the second side of the second nonwoven layer forms the lower surface of the composite nonwoven and at least 90% by weight of the composite nonwoven is polyester. Heat and pressure are applied to at least the upper surface of the composite nonwoven to at least partially melt the polyethylene terephthalate glycol fibers in the first nonwoven layer which hardens into a porous skin on the upper surface of the composite nonwoven forming the molded composite nonwoven.

### BRIEF DESCRIPTION OF THE FIGURES

An embodiment of the present invention will now be described by way of example, with reference to the accompanying drawings.

FIG. 1 illustrates schematically a cross-section of one embodiment of the composite nonwoven.

### DETAILED DESCRIPTION OF THE INVENTION

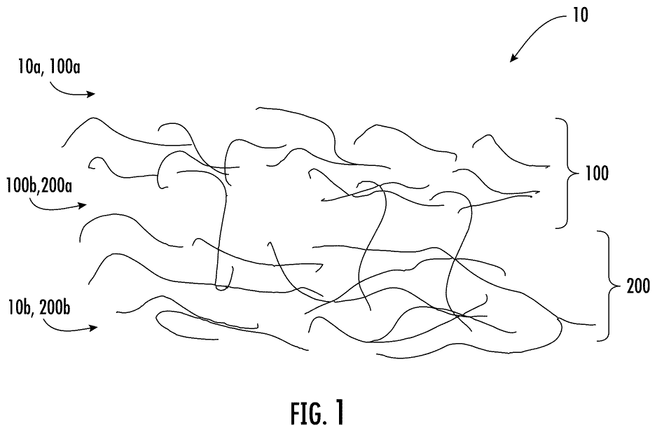

Referring to FIG. 1, there is shown one embodiment of a composite nonwoven 10 having an upper surface 10a and a lower surface 10b. The composite nonwoven 10 contains a first nonwoven layer 100 and a second nonwoven layer 200. The first nonwoven layer 100 contains a first side 100a and a second side 100b. The first side 100a of the first nonwoven layer 100 forms the upper surface 10a of the composite nonwoven 10. The composite nonwoven 10 also contains a second nonwoven layer 200 having a first side 200a and a second side 200b. The upper surface 200a of the second nonwoven layer 200 is contiguous to and needled to the second side 100b of the first nonwoven layer 100. The second side 200b second nonwoven layer 200 forms the lower surface 10b of the composite nonwoven 10. The first nonwoven layer and the second nonwoven layer are needled together preferably from the upper surface 10a of the composite nonwoven 10 such that at least a portion of the fibers from the first nonwoven layer 100 are needled into the second nonwoven layer 200.

The entire composite nonwoven essentially consists of polyester, where “essentially consists of” is defined in this application to be as least 90% wt. In a more preferred embodiment, the entire composite nonwoven contains at least 95% by weight, more preferably at least 98.5% by weight of polyester. Monomaterial compositions (material comprising the same polymer type) tend to eliminate chemical compatibility/bonding issues. In addition, constructions using the same material type can be more easily recycled and reused at end of life and also allows for the scraps produced during manufacture to be more easily recycled. Polyester is preferred as it has a high melt point as well as durability. Recycled polymer material may also be used for some end products to help make the product more environmentally friendly.

In one embodiment, the areal weight of the composite nonwoven 10 is between about 600 and 1800 g/m², more preferably between about 800 and 1400 g/m².

The first nonwoven layer 100 preferably forms the surface that a user would interact with which is sometimes referred to as the “A” or face surface. In one embodiment, the first side 100a of the first nonwoven layer 100 has a more smoothed appearance especially after molding the composite nonwoven.

After heat and pressure (when the composite is molded) is applied to the composite nonwoven 10 (preferably to the upper surface 10a and first nonwoven layer 100), at least a portion of the fibers at least partially melt and resolidify forming a porous skin. This skin reduces the air permeability of the molded composite nonwoven compared to the composite nonwoven before molding. As a result, the molded composite nonwoven tends to be high in sound absorption.

In one embodiment, the average thickness of the first nonwoven layer 100 is between about 1 mm and 10 mm, more preferably between about 2 mm and 5 mm. The thickness is defined as the distance between the first side 100a and the second side 100b of the first nonwoven layer 100 measured in 5-10 locations and averaged. The first nonwoven layer 100 preferably has an areal weight of between about 100 and 300 g/m², more preferably between about 120 and 180 g/m².

The first nonwoven layer 100 contains a plurality of fibers which are entangled to form the first nonwoven layer 100. Any suitable method of making the first nonwoven layer 100 may be used, for example mechanical bonding (needling), thermal bonding (melting fibers together), and chemical bonding (using adhesives); the specific process used depends on the desired properties of the final fabric with common techniques including spunbond, meltblown, wet-laid, and spunlace processes. Preferably the first nonwoven layer 100 is made using the mechanical bonding process. The fibers in the first nonwoven layer 100 are mostly polyethylene terephthalate glycol (PETG) fibers, preferably at least about 90% by weight of the first nonwoven layer 100. In another embodiment, the first nonwoven layer 100 contains at least about 90% by weight PETG. PETG provides significant chemical resistance, durability, and excellent formability for manufacturing because of its lower melting temperature. PETG can be easily vacuumed and pressure-formed as well as heat-bent thanks to its low forming temperatures. PETG typically has a glass transition temperature of around 85° C. and a melting temperature of between 220° C. and 260° C. PETG fibers are a mono material staple fiber that is meltable under the typical molding conditions of the composite nonwoven.

The composite nonwoven 10 also contains a second nonwoven layer 200 having a first side 200a and a second side 200b. In one embodiment, the average thickness of the second nonwoven layer 200 is between about 3 mm and 15 mm, more preferably between about 4 mm and 10 mm. The thickness is defined as the distance between the first side 200a and the second side 200b of the second nonwoven layer 200 measured in 5-10 locations and averaged. The second nonwoven layer 200 preferably has a weight of between about 500 and 1,500 g/m², more preferably between about 600 and 1200 g/m². In one embodiment, the second nonwoven layer 200 has a higher density than the first nonwoven layer 100. In one embodiment, the second nonwoven layer 200 has a greater average thickness than the first nonwoven layer 100. In one embodiment, the weight ratio of the first nonwoven layer to the second nonwoven layer is between about 1:15 to 1:2, more preferably between about 1:6 to 1:8.

The second nonwoven layer 200 contains a plurality of fibers which are entangled to form the second nonwoven layer 100. Any suitable method of making the second nonwoven layer 200 may be used, for example mechanical bonding (needling), thermal bonding (melting fibers together), and chemical bonding (using adhesives); the specific process used depends on the desired properties of the final fabric with common techniques including spunbond, meltblown, wet-laid, and spunlace processes. Preferably the second nonwoven layer 200 is made using the needling process (mechanical bonding). Preferably the second nonwoven layer 200 contains an intimate blend of a plurality of polyester terephthalate fibers, a plurality of first bi-component polyester fibers having a melting temperature of less than 140° C. and a plurality of second bi-component polyester fibers having a melting temperature of greater than 150° C. Preferably, the second nonwoven layer contains at least 90% by weight, more preferably at least 95% by weight, more preferably at least 98% by weight polyester fibers.

In one embodiment, the first bi-component polyester fibers have a melting temperature of between about 50 and 130° C. In another embodiment, the second bi-component polyester fibers have a melting temperature of between about 150 and 220° C. In one embodiment, the second nonwoven layer contains between about 30 and 80% by weight of polyester terephthalate fibers. In another embodiment, the second nonwoven layer contains between about 20 and 70% by weight of the plurality of first bi-component polyester fibers and the second bi-component polyester fibers together. In another embodiment, the second nonwoven layer contains between about 1 and 50% by weight of the first bi-component polyester fibers. In another embodiment, the second nonwoven layer contains between about 1 and 50% by weight of the second bi-component polyester fibers.

The lower melting point bi-component polyester fibers tend to give the finished and molded composite nonwoven rigidity and durability. The higher melting point bi-component polyester fibers tend to give the finished and molded composite nonwoven rigidity and durability and help with heat aging at high temperature conditions. The amounts of each bi-component polyester fiber can be tailored to achieve the desired flex modulus and tensile strength.

Utilizing these two nonwoven layers 100, 200 in the composite nonwoven 10 instead of a single nonwoven layer may have some advantages in the finished product, for example, the combination of the two nonwoven layers may produce a superior sound absorption. The sound absorption can be tailored by selecting the different fiber compositions, sizes, and densities of the two layers 100, 200.

Preferably, the first nonwoven layer 100 and the second nonwoven layer 200 are formed as two separate layers that are self-supporting and can be independently conveyed. These two layers 100, 200 are then connected together preferably by needling the two layers together. Preferably, the two layers are next to and contiguous to each other with no additional fibers, adhesives, or films between them. In one embodiment, the two layers 100, 200 are placed together and are needled together from at least one side.

In one embodiment, the needling is from the upper surface 10a of the composite nonwoven 10 (from the first nonwoven layer into the second nonwoven layer), pushing a portion of the polyethylene terephthalate glycol fibers from the first nonwoven layer into the second nonwoven layer. In this embodiment, the second nonwoven layer 200 contains some PETG fibers which is usually less than 5% by weight of the second nonwoven layer 200.

In another embodiment, the needling is from the lower surface 10b of the composite nonwoven 10 (from the second nonwoven layer into the first nonwoven layer), pushing a portion of the polyester terephthalate fibers, first bi-component polyester fibers, and second bi-component polyester fibers from the second nonwoven layer into the first nonwoven layer. In this embodiment, the first nonwoven layer 100 contains some polyester terephthalate fibers, first bi-component polyester fibers, and second bi-component polyester fibers, which is usually less than 5% by weight of the first nonwoven layer 100.

In another embodiment, the needling is from both the lower surface 10b of the composite nonwoven 10 (from the second nonwoven layer into the first nonwoven layer) and the upper surface 10a of the composite nonwoven 10 (from the first nonwoven layer into the second nonwoven layer). This pushes a portion of the polyester terephthalate fibers, first bi-component polyester fibers, and second bi-component polyester fibers from the second nonwoven layer into the first nonwoven layer and pushes a portion of the polyethylene terephthalate glycol fibers from the first nonwoven layer into the second nonwoven layer. In this embodiment, the first nonwoven layer 100 contains some polyester terephthalate fibers, first bi-component polyester fibers, and second bi-component polyester fibers, which is usually less than 5% by weight of the first nonwoven layer 100 and the second nonwoven layer 200 contains some PETG fibers which is usually less than 5% by weight of the second nonwoven layer 200.

The composite nonwoven 10 (before or after molding) may also contain some additional optional layers. These layers may be placed on the upper surface 10a or the lower surface 10b of the composite nonwoven 10 for additional properties and end uses. Preferably, these additional layers are also at least 90% by weight polyester as to allow for each recycling with the composite nonwoven 10.

After the composite nonwoven 10 is formed, it may be further process by molding into a molded composite nonwoven. The molding is performed using heat and optionally pressure. In one embodiment, the composite nonwoven is cut to shape, placed in a mold, molded using heat and pressure, then cooled and released from the mold. This molding process can transform the characteristics of the composite nonwoven, making it smoother, less air and/or water permeable, and less flexible, greater rigidity, and greater durability.

After molding, the plurality of polyethylene terephthalate glycol fibers in the first nonwoven layer 100 are at least partially melted and rehardened into a porous skin. This porous skin is especially useful to prevent ice from attaching to the molded composite nonwoven in the case where the molded composite nonwoven is used as a wheel well liner. After molding, at least a portion of the of the first bi-component polyester fibers having a melting temperature of less than 140° C. melt (more preferably the sheath polymer melts, and the core remains un-melted. These partially melted fibers within the second nonwoven layer fuse and attach the fibers within the second nonwoven layer together and provide strength and integrity to the molded composite nonwoven.

The molded composite nonwoven is preferably not as flexible as the unmolded composite nonwoven and can no longer be completely folded onto itself (a 180 degree fold) and then can be unfolded without any permanent changes in appearance or physical properties.

The molded nonwoven composite preferably becomes more rigid (also referred to as less flexible) than the composite nonwoven 10. Preferably, the molded nonwoven composite is stiff enough to support its own weight, hold its own shape, and may even be stiff enough to support additional weight without changing its shape.

The composite 10 may also contain any additional layers for physical or aesthetic purposes. Suitable additional layers include, but are not limited to, a nonwoven fabric, a woven fabric, a knitted fabric, a foam layer, a film, a paper layer, an adhesive-backed layer, a foil, a mesh, an elastic fabric (i.e., any of the above-described woven, knitted or nonwoven fabrics having elastic properties), an apertured web, an adhesive-backed layer, or any combination thereof. Other suitable additional layers include, but are not limited to, a color-containing layer (e.g., a print layer); one or more additional sub-micron fiber layers having a distinct average fiber diameter and/or physical composition; one or more secondary fine fiber layers for additional insulation performance (such as a melt-blown web or a fiberglass fabric); foams; layers of particles; foil layers; films; decorative fabric layers; membranes (i.e., films with controlled permeability, such as dialysis membranes, reverse osmosis membranes, etc.); netting; mesh; wiring and tubing networks (i.e., layers of wires for conveying electricity or groups of tubes/pipes for conveying various fluids, such as wiring networks for heating blankets, and tubing networks for coolant flow through cooling blankets); or a combination thereof. The additional layers may be on either or both sides of the nonwoven composite. For example, a textile may be applied to one side of the nonwoven composite using an optional adhesive layer to form an aesthetic surface for an end use such as certain automobile applications. In a preferred embodiment, any additional layers or materials added to the composite are also essentially all polyester to help with the recyclability of the composite.

In one embodiment, the composite nonwoven 10 contains an adhesive layer on the upper 10a or lower 10b surface of the composite nonwoven 10. The adhesive layer could contain a low melt polyester adhesive and may have a weight of between about 80 and 400 g/m². The adhesive layer may be incorporated into the composite nonwoven in any suitable method such as a liquid or molten coating or may be introduced as a free-standing film. Some examples of coating techniques are, but are not limited to, extrusion coating, solvent coating, gravure coating, knife coating, curtain coating, dip coating

In one embodiment, the composite nonwoven 10 contains a polymer film layer on the upper 10a or lower 10b surface of the composite nonwoven 10. The polymer film layer preferably contains a polyester and would be attached as a free standing film via adhesive to the composite nonwoven or as an extruded film layer being extruded directly onto the composite nonwoven.

The composite may further comprise one or more attachment devices to enable the composite to be attached to a substrate or other surface. In addition to adhesives, other attachment devices may be used such as mechanical fasteners like screws, nails, clips, staples, stitching, thread, hook and loop materials, etc.

The one or more attachment devices may be used to attach the composite to a variety of substrates. Exemplary substrates include, but are not limited to, a vehicle component; an interior of a vehicle (i.e., the passenger compartment, the motor compartment, the trunk, etc.); a wall of a building (i.e., interior wall surface or exterior wall surface); a ceiling of a building (i.e., interior ceiling surface or exterior ceiling surface); a building material for forming a wall or ceiling of a building (e.g., a ceiling tile, wood component, gypsum board, etc.); a room partition; a metal sheet; a glass substrate; a door; a window; a machinery component; an appliance component (i.e., interior appliance surface or exterior appliance surface); a surface of a pipe or hose; a computer or electronic component; a sound recording or reproduction device; a housing or case for an appliance, computer, etc. In another embodiment, the first side of the molded composite has lower surface roughness than the second side of the molded composite.

### Example 1

Example 1 was a commercially available single layer nonwoven. The single layer weighted approximately 900 gsm and contained the following fiber blend (all percentages by weight): 60% 6 denier polyester terephthalate (PET), 30% 4 denier bi-component polyester fibers having a melting temperature of 110° C., and 10% polypropylene fibers. The single layer nonwoven was formed using mechanical bonding.

The single layer nonwoven was then molded between two parallel platens with the heat being applied only to both sides to a temperature of 180° C. and a pressure of 1 ton for 60 sec.

### Example 2

Example 2 was a commercially available single layer nonwoven. The single layer weighted approximately 1300 gsm and contained the following fiber blend (all percentages by weight): 65% 6 denier polyester terephthalate (PET), 28% 4 denier bi-component polyester fibers having a melting temperature of 110° C., and 7% 4 denier bi-component polyester fibers having a melting temperature of 180° C. The single layer nonwoven was formed using mechanical bonding.

The single layer nonwoven was then molded between two parallel platens with the heat being applied only to both sides to a temperature of 180° C. and a pressure of 1 ton for 60 sec.

### Example 3

Example 3 was a composite nonwoven having two nonwoven layers. The first nonwoven layer weighted approximately 130 gsm and contained the following fiber blend (all percentages by weight): 95% 6 denier PETG and 5% 6 denier PET. The first nonwoven layer was formed using mechanical bonding. The second nonwoven layer weighted approximately 770 gsm and contained the following fiber blend (all percentages by weight): 60% 6 denier PET, 25% 4 denier bi-component polyester fibers having a melting temperature of 110° C., and 15% 4 denier bi-component polyester fibers having a melting temperature of 180° C. The second nonwoven layer was formed using mechanical bonding.

After the two nonwoven layers were formed, they were placed together with the first nonwoven layer on top of the second nonwoven layer (there were no other layers or adhesives between the two layers) and then the two layers were needled together by needling from the side of the first nonwoven layer.

The composite nonwoven was then molded between two parallel platens with the heat being applied only to one side (100) to a temperature of 150° C. and the other side (200) to a temperature of 180° C. and a pressure of 1 ton for 60 sec.

### Example 4

Example 4 was a commercially available single layer nonwoven. The single layer weighted approximately 1200 gsm and contained the following fiber blend (all percentages by weight): 63% 3 denier polyester terephthalate (PET), 23% 4 denier bi-component polyester fibers having a melting temperature of 110° C., and 14% 4 denier bi-component polyester fibers having a melting temperature of 180° C. The single layer nonwoven was formed using mechanical bonding.

The single layer nonwoven was then molded between two parallel platens with the heat being applied only to both sides to a temperature of 200° C. and a pressure of 1.2 ton for 80 sec.

### Example 5

Example 5 was a composite nonwoven having two nonwoven layers. The first nonwoven layer weighted approximately 130 gsm and contained the following fiber blend (all percentages by weight): 95% 6 denier PETG and 5% 6 denier PET. The first nonwoven layer was formed using mechanical bonding. The second nonwoven layer weighted approximately 1070 gsm and contained the following fiber blend (all percentages by weight): 67% 6 denier PET, 13% 4 denier bi-component polyester fibers having a melting temperature of 110° C., and 20% 4 denier bi-component polyester fibers having a melting temperature of 180° C. The second nonwoven layer was formed using mechanical bonding.

After the two nonwoven layers were formed, they were placed together with the first nonwoven layer on top of the second nonwoven layer (there were no other layers or adhesives between the two layers) and then the two layers were needled together by needling from the side of the first nonwoven layer.

The composite nonwoven was then molded between two parallel platens with the heat being applied one side (100) to a temperature of 150° C. and the other side (200) to a temperature of 200° C. a pressure of 1.2 ton for 80 sec.

The examples were all tested for rigidity, durability, and sound absorption. Rigidity of the molded examples was tested using ISO 178. Durability of the molded examples was tested using ASTM D638. Sound absorption of the molded examples was tested using Sound Absorption Coefficient Measurement Method at Reverberation Room.

| Example | Rigidity (MPa) | Durability (N) |
|---|---|---|
| 1 | 185 | 282 |
| 2 | 222 | 264 |
| 3 | 171 | 273 |
| 4 | 304 | 294 |
| 5 | 268 | 287 |

Sound Absorption Coefficient Data from 500 Hz to 2500 Hz Frequency.

| Example | 500 Hz | 630 Hz | 1000 Hz | 1250 Hz | 1600 Hz | 2500 Hz |
|---|---|---|---|---|---|---|
| 1 | 0.06 | 0.15 | 0.28 | 0.36 | 0.45 | 0.73 |
| 2 | 0.07 | 0.11 | 0.18 | 0.28 | 0.36 | 0.66 |
| 3 | 0.11 | 0.19 | 0.42 | 0.56 | 0.68 | 0.82 |
| 4 | 0.12 | 0.19 | 0.37 | 0.49 | 0.66 | 0.79 |
| 5 | 0.21 | 0.28 | 0.4 | 0.57 | 0.66 | 0.84 |

As one can see from the data above, the single layer examples 1, 2, and 4 and the two layer examples 3 and 5 had similar rigidity and durability results but the two layer examples had improved sound absorption.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A composite nonwoven having an upper surface and a lower surface and comprising:
a first nonwoven layer having a first side and a second side, wherein the first side of the first nonwoven layer forms the upper surface of the nonwoven composite, wherein the first nonwoven layer comprises a plurality of polyethylene terephthalate glycol fibers and wherein the first nonwoven layer comprises at least 90% by weight polyethylene terephthalate glycol;
a second nonwoven layer having a first and second side, wherein the second nonwoven layer is oriented such that the first side of the second nonwoven layer faces the second side of the first nonwoven layer and the second side of the second nonwoven layer forms the lower surface of the composite nonwoven, wherein the second nonwoven layer comprises an intimate blend of a plurality of polyester terephthalate fibers, a plurality of first bi-component polyester fibers having a melting temperature of less than 140° C. and a plurality of second bi-component polyester fibers having a melting temperature of greater than 150° C.;
wherein at least a portion of the polyethylene terephthalate glycol fibers from the first nonwoven layer are needled into the second nonwoven layer, and at least 90% by weight of the composite nonwoven is polyester.

2. The composite nonwoven of claim 1, wherein at least 98.5% by weight of the composite nonwoven is polyester.

3. The composite nonwoven of claim 1, wherein the first nonwoven layer has a weight of between about 100 and 300 g/m².

4. The composite nonwoven of claim 1, wherein the second nonwoven layer has a weight of between about 500 and 1500 g/m².

5. The composite nonwoven of claim 1, wherein the weight ratio of the first nonwoven layer to the second nonwoven layer is between about 1:15 to 1:2.

6. The composite nonwoven of claim 1, wherein the second nonwoven layer comprises between about 30 and 80% by weight of the plurality of polyester terephthalate fibers.

7. The composite nonwoven of claim 1, wherein the second nonwoven layer comprises between about 20 and 70% by weight of the plurality of first bi-component polyester fibers and the second bi-component polyester fibers together.

8. A process of forming a composite nonwoven having an upper surface and a lower surface and comprising the steps of:
forming a first nonwoven layer by entangling a plurality of polyethylene terephthalate glycol fibers, wherein the first nonwoven layer has a first side and a second side and wherein the first nonwoven layer comprises at least 90% by weight polyethylene terephthalate glycol;
forming a second nonwoven layer by entangling a plurality polyester terephthalate fibers, a plurality of first bi-component polyester fibers having a melting temperature of less than 140° C. and a plurality of second bi-component polyester fibers having a melting temperature of greater than 150° C., wherein the second nonwoven layer has a first and second side, and wherein the second nonwoven layer is oriented such that the first side of the second nonwoven layer faces the second side of the first nonwoven layer;
needling the first nonwoven layer and the second nonwoven layer together, pushing a portion of the polyethylene terephthalate glycol fibers from the first nonwoven layer into the second nonwoven layer;
wherein the first side of the first nonwoven layer forms the upper surface of the nonwoven composite and the second side of the second nonwoven layer forms the lower surface of the composite nonwoven and wherein at least 90% by weight of the composite nonwoven is polyester.

9. The process of claim 8, wherein at least 98.5% by weight of the composite nonwoven is polyester.

10. The process of claim 8, wherein the weight ratio of the first nonwoven layer to the second nonwoven layer is between about 1:15 to 1:2.

11. The process of claim 8, wherein the second nonwoven layer comprises between about 30 and 80% by weight of the plurality of polyester terephthalate fibers.

12. A molded composite nonwoven having an upper surface and a lower surface and comprising:
a first nonwoven layer having a first side and a second side, wherein the first side of the first nonwoven layer forms the upper surface of the nonwoven composite, wherein the first nonwoven layer comprises a plurality of polyethylene terephthalate glycol fibers, wherein at least a portion of the polyethylene terephthalate glycol fibers have been at least partially melted and rehardened into a porous skin, and wherein the first nonwoven layer comprises at least 90% by weight polyethylene terephthalate glycol;
a second nonwoven layer having a first and second side, wherein the second nonwoven layer is oriented such that the first side of the second nonwoven layer faces the second side of the first nonwoven layer and the second side of the second nonwoven layer forms the lower surface of the composite nonwoven, wherein the second nonwoven layer comprises in intimate blend of a plurality of polyester terephthalate fibers, a plurality of first bi-component polyester fibers having a melting temperature of less than 140° C. and a plurality of second bi-component polyester fibers having a melting temperature of greater than 150° C.;
wherein at least a portion of the wherein at least a portion of the polyethylene terephthalate glycol fibers from the first nonwoven layer are needled into the second nonwoven layer, and at least 90% by weight of the composite nonwoven is polyester.

13. The molded composite nonwoven of claim 12, wherein at least 98.5% by weight of the composite nonwoven is polyester.

14. The molded composite nonwoven of claim 12, wherein the first nonwoven layer has a weight of between about 100 and 300 g/m².

15. The molded composite nonwoven of claim 12, wherein the weight ratio of the first nonwoven layer to the second nonwoven layer is between about 1:15 to 1:2.

16. The molded composite nonwoven of claim 12, wherein the second nonwoven layer comprises between about 30 and 80% by weight of the plurality of polyester terephthalate fibers.

17. The molded composite nonwoven of claim 12, wherein the second nonwoven layer comprises between about 20 and 70% by weight of the plurality of first bi-component polyester fibers and the second bi-component polyester fibers together.

18. A process of forming a molded composite nonwoven having an upper surface and a lower surface and comprising the steps of:
spin bonding a plurality of polyethylene terephthalate glycol fibers to form a first nonwoven layer having a first side and a second side and wherein the first nonwoven layer comprises at least 90% by weight polyethylene terephthalate glycol;
spin bonding a plurality polyester terephthalate fibers, a plurality of first bi-component polyester fibers having a melting temperature of less than 140° C. and a plurality of second bi-component polyester fibers having a melting temperature of greater than 150° C. to form a second nonwoven layer having a first and second side, wherein the second nonwoven layer is oriented such that the first side of the second nonwoven layer faces the second side of the first nonwoven layer;
needling the first nonwoven layer and the second nonwoven layer together forming a composite nonwoven, pushing a portion of the polyethylene terephthalate glycol fibers from the first nonwoven layer into the second nonwoven layer, wherein the first side of the first nonwoven layer forms the upper surface of the nonwoven composite and the second side of the second nonwoven layer forms the lower surface of the composite nonwoven and wherein at least 90% by weight of the composite nonwoven is polyester;
applying heat and pressure to at least the upper surface of the composite nonwoven to at least partially melt the polyethylene terephthalate glycol fibers in the first nonwoven layer which hardens into a porous skin on the upper surface of the composite nonwoven forming the molded composite nonwoven.

19. The process of claim 18, wherein the weight ratio of the first nonwoven layer to the second nonwoven layer is between about 1:15 to 1:2.

20. The process of claim 18, wherein the second nonwoven layer comprises between about 20 and 70% by weight of the plurality of first bi-component polyester fibers and the second bi-component polyester fibers together.
